(19) United States
(12) Patent Application Publication
(10) Pub. No.: US 2006/0209180 A1
(43) Pub. Date: Sep. 21, 2006

(54) Display apparatus and control method thereof

(76) Inventor: Seung-ho Jang, Suwon-si (KR)

Correspondence Address: STANZIONE & KIM, LLP, 919 18TH STREET, N.W., SUITE 440, WASHINGTON, DC, 20006, US

(21) Appl. No.: 11/340,658

(22) Filed: Jan. 27, 2006

(30) Foreign Application Priority Data
Mar. 8, 2005 (KR) 2005-0019342
May 30, 2005 (KR) 2005-0045769

(51) Int. Cl. H04N 7/14; H04N 5/44; G08C 19/00

(52) U.S. Cl. 348/14.05; 348/734; 340/825.72

(57) ABSTRACT

A display apparatus having a display includes a user input part including a function-adjusting selector to transmit a function-adjusting signal and a locking selector to select a locking function, and a controller to perform a function according to the function-adjusting signal received from the function-adjusting selector, and to disable the function according to the function-adjusting signal if the locking function is selected through the locking selector. The display apparatus and a control method thereof prevent unauthorized users from using the display apparatus since a function according to a function-adjusting signal input to the display apparatus is not performed if the locking function is active.

CROSS-REFERENCE TO RELATED APPLICATIONS

This application claims the benefit under 35 U.S.C. § 119 from Korean Patent Application No. 2005-19342, filed on Mar. 8, 2005, and Korean Patent Application No. 2005-45769, filed on May 30, 2005, in the Korean Intellectual Property Office, the disclosures of which are incorporated herein by references in their entirety.

### BACKGROUND OF THE INVENTION

1. Field of the Invention

The present general inventive concept relates to a display apparatus and a control method, and more particularly, to a display apparatus capable of activating/deactivating a locking function so that display apparatus adjusting functions are disabled when the locking function is active, and a control method performing a locking function.

2. Description of the Related Art

In general, a display apparatus receives an image signal from an image signal source like a TV broadcasting system, and displays an image according to the received image signal on a screen. The display apparatus has evolved from a display apparatus using a cathode ray tube (“CRT”) to a flat display apparatus using a liquid crystal display (“LCD”), a plasma display panel (“PDP”), or the like and the displayed image quality has increased as well.

In the conventional display apparatus, any user (authorized or not) may alter the displayed image (e.g. change a channel displayed on a TV or adjust functions of the display apparatus such as volume, a timer, etc.).

Accordingly, somebody unauthorized may change a set-up mode of the display apparatus or use a stolen display apparatus.

### SUMMARY OF THE INVENTION

The present general inventive concept provides a display apparatus capable of activating/deactivating a locking function so that adjusting functions are disabled when the locking function is active, and a control method thereof that prevents unauthorized users from using the display apparatus when the locking function is active.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a display apparatus comprising a display to display images, a user input part including a function-adjusting selector to input a function-adjusting signal and a locking selector to select a locking function, and a controller to perform a function according to the function-adjusting signal received from the function-adjusting selector, and to disable the function according to the function-adjusting signal if the locking function is selected through the locking selector.

The display apparatus may further comprise a memory to store a reference password, and an interface generator to generate a password interface screen to input a comparative password, wherein the controller controls the interface generator to generate the password interface screen and controls the display to display the password interface screen if the locking function is selected and activates the locking function if the comparative password input through the user input part is consistent with the reference password.

The user input part may comprise a remote controller having an ID storage to store a comparative ID.

The memory may further store a reference ID, the user input part may comprise a signal output part to output the comparative ID, and the controller activates the locking function if determining that the comparative ID is consistent with the reference ID.

The controller may enable the function according to the function-adjusting signal if a releasing function, which deactivates the locking function, is selected through the user input part.

The controller may deactivate the locking function if the comparative password input through the user input part is consistent with the reference password stored in the memory when the releasing function is selected.

The controller may control the display to display the password interface screen when the releasing function is selected through the user input part and deactivates the locking function if the comparative password input through the password interface screen is consistent with the reference password.

The controller releases the locking function if determining that the comparative ID is consistent with the reference ID.

The controller may control the display a screen to inform that the locking function is active if the function-adjusting signal is received while the locking function is active.

The function-adjusting signal may not comprise a signal to power-on/off of the display apparatus.

The user input part may comprise a lock key to select the locking function.

The foregoing and/or other aspects of the present general inventive concept may also be achieved by providing a control method of a display apparatus including a display and a user input part to receive a predetermined function-adjusting signal, the method comprising receiving a locking signal; and disabling a function corresponding to the predetermined function-adjusting signal.

The control method of the display apparatus may further comprise providing a reference password, receiving a comparative password, determining whether the comparative password is consistent with the reference password, and disabling the function corresponding to the predetermined function-adjusting signal if the comparative password is consistent with the reference password.

The control method of the display apparatus may further comprise receiving a comparative ID of the user input part.

The control method of the display apparatus may further comprise providing a reference ID; and activating a locking function according to a locking signal input from the user input part if the comparative ID is consistent with the reference ID.

The control method of the display apparatus may further comprise receiving a releasing signal, inputting the comparative password, determining whether the comparative password is consistent with the reference password, and enabling the function corresponding to the predetermined function-adjusting signal when receiving the releasing signal if the comparative password is consistent with the reference password.

The control method of the display apparatus may further comprise displaying a password interface screen to input the comparative password if the locking signal is received.

The control method of the display apparatus may further comprise displaying the password interface screen on the display if the releasing signal is received.

The control method of the display apparatus may further comprise receiving the predetermined function-adjusting signal when the function according to the predetermined function-adjusting signal is disabled, and displaying a screen to inform that the function is disabled on the display.

The predetermined function-adjusting signal does not comprise an input signal to power-on/off of the display apparatus.

The foregoing and/or other aspects of the present general inventive concept may also be achieved by providing a display apparatus including an adjustment unit to generate and output adjusting commands and identification information, and a display to display images according to a received image signal, to store reference information, and to adjust the display if adjusting commands received from the adjustment control unit if the identification information is consistent with the reference information.

The foregoing and/or other aspects of the present general inventive concept may also be achieved by providing a method of disabling/enabling functions to adjust condition of a display apparatus, the method including selecting a locking function, checking whether comparative ID information associated with the locking function is consistent with reference ID information, and switching between a locked state in which the functions to adjust the condition of the display apparatus are disabled and an unlocked state in which the functions to adjust the condition of the display apparatus are enabled based on a comparison between the comparative ID information and the reference ID information.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a control block diagram of a display apparatus according to an embodiment of the present general inventive concept;

FIG. 2 is a lock key to input a locking signal in the display apparatus according to an embodiment of the present general inventive concept;

FIGS. 3A-3C illustrate interface screens displayed on the display apparatus according to an embodiment of the present general inventive concept; and

FIG. 4 is a control flow chart of a control method of activating and deactivating a locking function according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

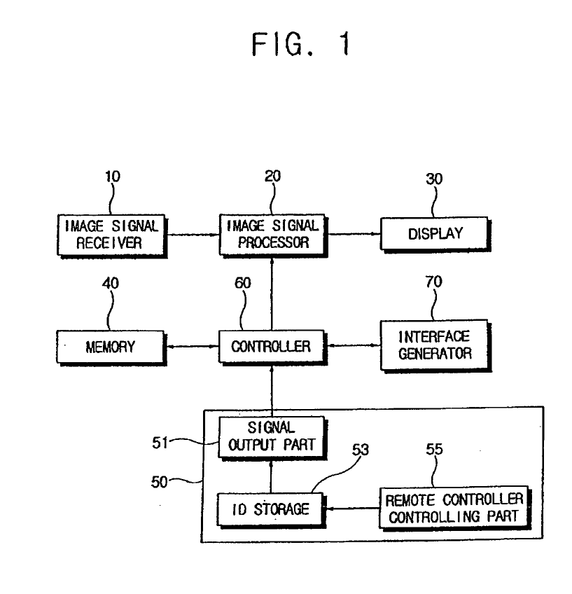

FIG. 1 is a control block diagram of a display apparatus according to an embodiment of the present general inventive concept. As illustrated in FIG. 1, the display apparatus according to the present embodiment comprises a display 30, a memory 40, a user input part 50 to enable a user to input predetermined information, and a controller 60. Also, the display apparatus may further comprise an image signal receiver 10 to receive an image signal (e.g. a broadcast signal) from an external source, an interface generator 70 to generate interface screens, and an image signal processor 20 to process the image signal received from the external source.

The image signal receiver 10 receives the image signal from the external source. For example, if the display apparatus is a TV, when a broadcasting signal having a wide-range of frequencies is received by the image signal receiver 10, the display 30 may display images according to a portion of the broadcasting signal through a channel corresponding to a carrier frequency.

According to types of the image signal received by the image signal receiver 10, the image signal processor 20 may decode an analog signal (e.g. a composite video baseband signal (“CVBS”) or a S-video signal), may convert an analog signal (e.g. a component signal or a PC video signal) into a digital video signal, or may divide a digital video signal (e.g. a DVI video signal) into digital signals for red, blue, and green (RGB), and horizontal and vertical (HN) synchronous signals. Further, the image signal processor 20 may convert the image signal into a format so that images according to the input signal can be displayed on the display 30.

The memory 40 stores a reference password. The display apparatus according to the present embodiment may store in the memory 40 the reference password set by the user, or a default value such as 0000, 1234 or the like input as the reference password by the display apparatus manufacturer. Additionally, the memory 40 may further store a predetermined reference identifier (ID). The predetermined reference ID may be a serial number of the display apparatus. However, the present general inventive concept is not limited to having the serial number as the predetermined reference ID, and may accommodate various alternative ways of storing a predetermined reference ID.

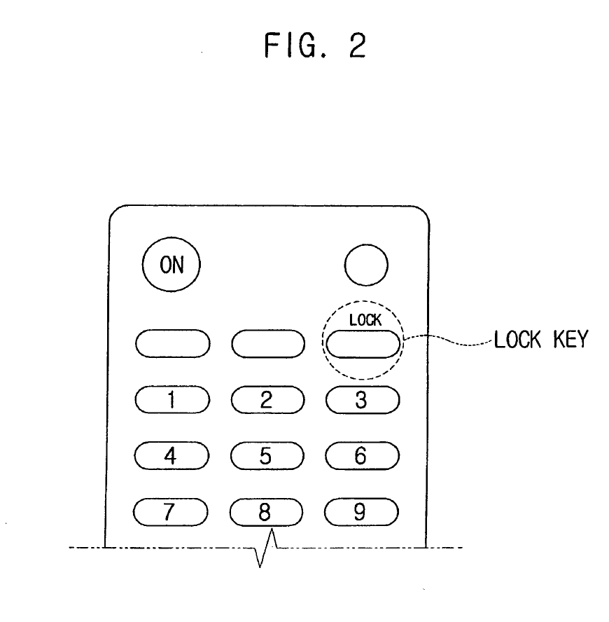

The user input part 50 enables the user to input or select a predetermined function. The user input part 50 may be realized with a plurality of input keys, buttons, etc. The user may input or select the predetermined function from a plurality of available functions to adjust a condition of the display apparatus such as changing the channel, timer, volume, etc. When the user inputs or selects the predetermined function, a corresponding function-adjusting signal is generated by the user input part 50 and transmitted to the controller 60. That is, the function-adjusting signal carries information to perform the selected (input) predetermined function. The user input part 50 may comprise a remote controller, on which an additional lock key to activate/deactivate a locking function may be provided as illustrated in FIG. 2.

When the user input part 50 comprises the remote controller, the remote controller may comprise an ID storage 53 to store a predetermined comparative ID, a signal output part 51 to output the predetermined comparative ID and the function-adjusting signal, and a remote controller controlling part 55 to control the ID storage 53 and the signal output part 51. If the serial number of the display apparatus is stored in the memory as the predetermined reference ID, the ID storage 53 may store the same serial number of the display apparatus as the predetermined comparative ID. Accordingly, the locking function may be activated or deactivated only by using the remote controller having the serial number of the display apparatus as the predetermined comparative ID.

When the user selects the lock key, the remote controller controlling part 55 may output the predetermined comparative ID stored in the ID storage 53 as well as a locking or unlocking signal corresponding to the lock key to the display apparatus.

The interface generator 70 may generate a plurality of interface screens to be displayed on the display 30. The interface generator 70 may be included in the image signal processor 20 or may be provided as an additional integrated circuit (IC).

When the user selects the lock key, the controller 60 can activate the locking function to prevent the display apparatus from performing the predetermined function corresponding to the function-adjusting signal received from the user input part 50. However, the controller 60 can perform the predetermined function corresponding to the function-adjusting signal after the user deactivates the locking function (i.e. the locking function becomes inactive).

When the user selects the lock key, the controller 60 determines whether a comparative password is consistent with the reference password stored in the memory 40. The comparative password may be input using the user input part 50.

The controller 60 may activate/deactivate the locking function if the comparative password is consistent with the reference password. Alternatively, the controller 60 may control the interface generator 70 to generate a password interface screen so that the comparative password may be input on the display 30 when the user selects the lock key.

The user input part 50 may include an undo key so that the locking function may be deactivated when the user selects the undo key. In this case, when the undo key is selected, the controller 60 controls the interface generator 70 to generate the password interface screen so that the comparative password may be input on the display 30. The lock key may also deactivate the locking function.

The controller 60 receives the predetermined comparative ID from the remote controller. Then, if the predetermined comparative ID is also consistent with the predetermined reference ID, the controller 60 determines whether the reference password is consistent with the comparative password and activates/deactivates the locking function.

The controller 60 does not perform the predetermined function corresponding to the function-adjusting signal input from the user input part 50 if the locking function is active. In this case, the function-adjusting signal, which is a signal to adjust the condition of the display apparatus, may comprise signals corresponding to one or more available functions input from the user input part 50, such as signals to adjust the channel, timer, volume, etc. However, the function-adjusting signal may not comprise a signal to power-on/off the display apparatus. That is, since the power-on/off functions can be performed while the locking function is active, the controller 60 enables the lock key and the undo key to activate or deactivate the locking function whenever the displayed apparatus has the power on. Namely, the controller 60 may activate the locking function while the display apparatus has the power on and then the display apparatus may be turned off (i.e. has the power off). Thereafter, when the display apparatus has the power on again, the controller 60 may deactivate the locking function.

If the function-adjusting signal is input through the user input part 50 while the locking function is active, the controller 60 may control displaying on the display 30 an interface screen generated by the interface generator 70 to signal that the locking function is active. Alternatively, a voice or a mechanical message may signal that the locking function is active.

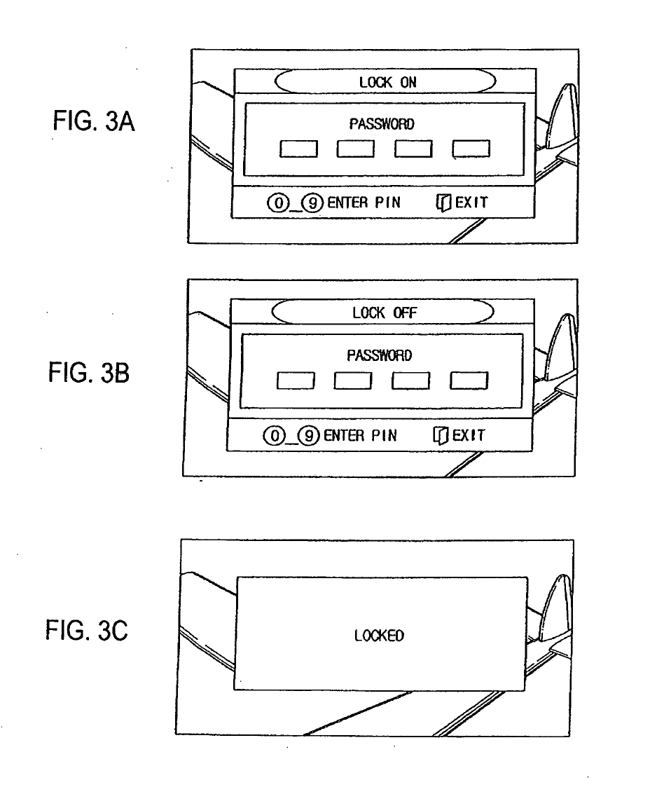

FIG. 2 illustrates the lock key on the remote controller and FIGS. 3A-3C illustrate interface screens generated by the interface generator 70 and displayed on the display 30 according to the present embodiment. As illustrated in FIGS. 2 and 3A-3C, the display apparatus according to the present embodiment may comprise the remote controller as the user input part 50. On the remote controller, the lock key may be provided to activate the locking function. The lock key may also deactivate the locking function if the user inputs the lock key while the locking function is active. Alternatively, the undo key may be provided on the remote controller, although not illustrated in drawings. If the user inputs the undo key while the locking function is active, the locking function may be deactivated.

If the user selects the lock key to activate the locking function, the password interface screen is displayed on the display 30, as illustrated in FIG. 3A. If the user inputs the comparative password through the password interface screen and the comparative password is consistent with the reference password, the locking function is activated in the display apparatus. If the function-adjusting signal is input through the user input part 50 while the locking function is active, the interface screen signaling that the locking function is active may be displayed on the display 30, as illustrated in FIG. 3C.

If the lock key or the undo key is input while the locking function is active, the password interface screen may be displayed on the display 30, as illustrated in FIG. 3B. If the user inputs the comparative password through the password interface screen and the comparative password is consistent with the reference password, the locking function is deactivated in the display apparatus. However, if the two passwords are not consistent with each other, the locking function remains active.

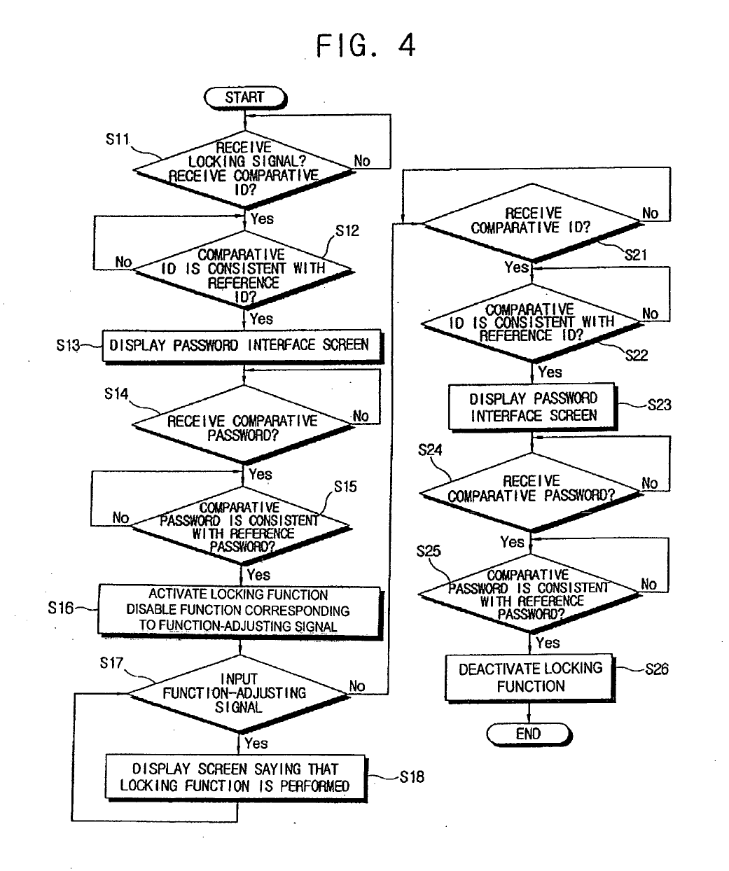

FIG. 4 is a control flow chart of a method of activating and deactivating the locking function in the display apparatus described above, according to an embodiment of the present general inventive concept. The method illustrated in FIG. 4 is described as being performed by the display apparatus illustrated in FIG. 2, but the present general inventive concept is not limited by this description and the method may be performed by various other embodiments.

As illustrated in FIG. 4, if the user inputs the lock key in the user input part 50, the controller 60 receives a locking signal and the predetermined comparative ID from the user input part 50 in order to activate the locking function, at operation S11. In this case, the controller 60 determines whether the predetermined comparative ID is consistent with the predetermined reference ID stored in the memory 40, at operation S12, and enables activating the locking function only if the two IDs are consistent with each other. If the predetermined reference ID is consistent with the predetermined comparative ID, the controller 60 controls the interface generator 70 to generate the password interface screen and the display 30 to display the password interface screen at operation S13. When the comparative password is input through the password interface screen, at operation S14, the controller 60 determines whether the comparative password is consistent with the reference password stored in the memory 40, at operation S15. The controller 60 does not activate the locking function if the two passwords are not consistent with each other. If the comparative password is determined to be consistent with the reference password, at the operation S15, the controller 60 activates the locking function. That is, when the locking function is active, the controller 60 does not respond to the function-adjusting signal input to the display apparatus because the function corresponding to the function-adjusting signal is disabled, at operation S16. Even if the function-adjusting signal is input, the controller 60 does not acknowledge the function-adjusting signal or alternatively does not perform the corresponding function thereby, at operation S16, although acknowledging the function-adjusting signal.

The function-adjusting signal is input through the user input part 50 while the locking function is active, at operation S17, and the function corresponding to the function-adjusting signal is disabled. Then, the controller 60 controls the interface generator 70 to generate an interface screen (e.g. as illustrated in FIG. 3C) to signal that the locking function is active, and controls the display 30 to display the interface screen, at operation S18.

When the user inputs the undo key or the lock key, the controller 60 receives an unlocking (a releasing) signal and the predetermined comparative ID through the user input part 50, at operation S21. At this time, the controller 60 determines whether the predetermined comparative ID is consistent with the predetermined reference ID stored in the memory 40, at operation S22. The controller 60 allows deactivating the locking function only if the two IDs are consistent with each other. The controller 60 controls the interface generator to generate the password interface screen and the display 30 to display the password interface screen if the two IDs are consistent with each other, at operation S23. If the comparative password is input through the password interface screen, at operation S24, the controller 60 determines whether the comparative password is consistent with the reference password stored in the memory 40, at operation S25. The controller 60 does not deactivate the locking function if determining that the two passwords are not consistent with each other. The controller 60 deactivates the locking function if the two passwords are consistent with each other, at operation S26.

In the present embodiment, the comparative password may be input through a key on the display apparatus according to the present general inventive concept. However, the comparative password may be input through a predetermined graphic or fingerprint and face recognition method.

Consequently, the display apparatus according to an embodiment of the present general inventive concept may be used only by the user who knows the reference password when the locking function is active thereby preventing someone who does not know the reference password (i.e. an unauthorized user) from using the display apparatus. Additionally, if the display apparatus comprises a remote controller having a lock key, someone can not use the display apparatus without the remote controller because the locking function can not be deactivated without the remote controller, which has the comparative ID consistent with the reference ID stored in the display apparatus. Accordingly, an unauthorized user may not adjust the condition of the display apparatus, thereby providing a display apparatus having a security feature.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus, comprising:
a display to display images;
a user input part including a function-adjusting selector to transmit a function-adjusting signal and a locking selector to select a locking function; and
a controller to perform a function according to the function-adjusting signal received from the function-adjusting selector, and to disable the function according to the function-adjusting signal if the locking function is selected through the locking selector.

2. The display apparatus according to claim 1, further comprising:
a memory to store a reference password; and
an interface generator to generate a password interface screen to input a comparative password, wherein the controller controls the interface generator to generate the password interface screen and controls the display to display the password interface screen if the locking function is selected, and activates the locking function if the comparative password input through the user input part is consistent with the reference password.

3. The display apparatus according to claim 2, wherein the user input part comprises a remote controller having an ID storage to store a comparative ID.

4. The display apparatus according to claim 3, wherein the memory further stores a reference ID, the user input part comprises a signal output part to output the comparative ID, and the controller activates the locking function if determining that the comparative ID is consistent with the reference ID.

5. The display apparatus according to claim 4, wherein the controller enables the function according to the function-adjusting signal if a releasing function, which deactivates the locking function, is selected through the user input part.

6. The display apparatus according to claim 5, wherein the controller deactivates the locking function if the comparative password input through the user input part is consistent with the reference password stored in the memory when the releasing function is selected.

7. The display apparatus according to claim 6, wherein the controller controls the display to display the password interface screen when the releasing function is selected through the user input part and deactivates the locking function if the comparative password input through the password interface screen is consistent with the reference password.

8. The display apparatus according to claim 7, wherein the controller deactivates the locking function if determining that the comparative ID is consistent with the reference ID.

9. The display apparatus according to claim 2, wherein the controller controls the display to display a screen to inform that the locking function is active if the function-adjusting signal is received while the locking function is active.

10. The display apparatus according to claim 2, wherein the function-adjusting signal does not comprise a signal to power-on/off the display apparatus.

11. The display apparatus according to claim 1, wherein the user input part comprises a lock key to select the locking function.

12. The display apparatus according to claim 1, wherein the user input part comprises:
a plurality of function keys corresponding to a plurality of functions;
a buffer to store predetermined identification data; and
an output module to submit selected functions and the locking function.

13. The display apparatus according to claim 12, wherein the user input part further comprises:
a plurality of input keys to enable a user to input a comparative password.

14. A control method of a display apparatus including a display and a user input part to receive a predetermined function-adjusting signal, the control method comprising:
receiving a locking signal; and
disabling a function corresponding to the predetermined function-adjusting signal.

15. The control method of the display apparatus according to claim 14, further comprising:
providing a reference password;
receiving a comparative password;
determining whether the comparative password is consistent with the reference password; and
disabling the function corresponding to the predetermined function-adjusting signal if the comparative password is consistent with the reference password.

16. The control method of the display apparatus according to claim 15, further comprising:
receiving a comparative ID from the user input part.

17. The control method of the display apparatus according to claim 16, further comprising:
providing a reference ID; and
activating a locking function according to a locking signal received by the user input part if the comparative ID is consistent with the reference ID.

18. The control method of the display apparatus according to claim 17, further comprising:
receiving a releasing signal;
inputting the comparative password;
determining whether the comparative password is consistent with the reference password; and
enabling the function corresponding to the predetermined function-adjusting signal when receiving the releasing signal if the comparative password is consistent with the reference password.

19. The control method of the display apparatus according to claim 18, further comprising:
displaying a password interface screen to input the comparative password if the locking signal is received.

20. The control method of the display apparatus according to claim 19, further comprising:
displaying the password interface screen on the display if the releasing signal is received.

21. The control method of the display apparatus according to claim 14, further comprising:
receiving the predetermined function-adjusting signal when the function according to the predetermined function-adjusting signal is disabled; and
displaying a screen to inform that the function is disabled on the display.

22. The control method of the display apparatus according to claim 14, wherein the predetermined function-adjusting signal does not comprise an input signal for power-on/off of the display apparatus.

23. A display apparatus, comprising:
an adjustment unit to generate and output adjusting commands and identification information; and
a display to display images according to a received image signal, to store reference information, and to adjust the display according to the adjusting commands received from the adjustment control unit if the identification information is consistent with the reference information.

24. A method of disabling/enabling functions to adjust conditions of a display apparatus, the method comprising:
selecting a locking function;
checking whether comparative ID information associated with the locking function is consistent with reference ID information; and
switching between a locked state in which the functions to adjust the condition of the display apparatus are disabled and an unlocked state in which the functions to adjust the condition of the display apparatus are enabled based on a comparison between the comparative ID information and the reference ID information.
